(19) United States
(12) Patent Application Publication
(10) Pub. No.: US 2026/0094060 A1
(43) Pub. Date: Apr. 2, 2026

(54) UE INITIATED MODEL-UPDATES FOR TWO-SIDED AI/ML MODEL

(71) Applicant: Nokia Technologies Oy, Espoo (FI)

(72) Inventors: Keeth Saliya Jayasinghe LADDU, Espoo (FI); Amaanat ALI, Espoo (FI); Mihai ENESCU, Espoo (FI)

(21) Appl. No.: 19/113,299

(22) PCT Filed: Aug. 2, 2023
(86) PCT No.: PCT/EP2023/071405

§ 371 Date: Mar. 19, 2025

(30) Foreign Application Priority Data
Sep. 22, 2022 (GB) 2213827.5

(51) Int. Cl. G06N 20/00; H04L 41/16; H04W 24/02

(52) U.S. Cl. CPC G06N 20/00; H04L 41/16; H04W 24/02

(57) ABSTRACT

A method comprising obtaining, at a terminal assigned to a network, a configuration with parameters that enable the terminal to initiate an uplink, UL, transmission related to an update at the terminal at least for a terminal part of a two-sided model used at the terminal, wherein the two-sided model is used for joint model inference at the terminal side and the network side; determining that an update of the two-sided model is required; initiating, based on the obtained configuration, a first UL transmission; transmitting the initiated first UL transmission indicating the required update; receiving a response comprising update information related to the required update; and based on the received response, establishing an update of the terminal part of the two-sided model.

### TECHNICAL FIELD

The present disclosure relates to a method and an apparatus for user equipment (UE) initiated model-updates for a two-sided Artificial Intelligence/Machine Learning (AI/MI) model.

### BACKGROUND ART

The following description of background art may include insights, discoveries, understandings or disclosures, or associations, together with disclosures not known to the relevant prior art, to at least some examples of embodiments of the present disclosure but provided by the disclosure. Some of such contributions of the disclosure may be specifically pointed out below, whereas other of such contributions of the disclosure will be apparent from the related context.

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

In such context, the 3GPP document RP-213599, Release 18 Study Item (SI) on Artificial Intelligence (AI)/Machine Learning (ML) for New Radio (NR) Air Interface, aims at exploring the benefits of augmenting the air interface with features enabling support of AI/ML-based algorithms for enhanced performance and/or reduced complexity/overhead. This SI's target is to lay the foundation for future air-interface use cases leveraging AI/ML techniques. The initial set of use cases to be covered include Channel State Information (CSI) feedback enhancement (e.g., overhead reduction, improved accuracy, prediction), beam management (e.g., beam prediction in time, and/or spatial domain for overhead and latency reduction, beam selection accuracy improvement), positioning accuracy enhancements. For those use cases the benefits shall be evaluated (utilizing developed methodology and defined key performance indicators (KPIs)) and potential impact on the specifications shall be assessed including PHY layer aspects, protocol aspects.

One of the key expected outcomes of the SI is that the AI/ML approaches need to be diverse enough to support various requirements on gNB-UE collaboration levels.

It must be noted that in the WI phase of “AI/ML for air interface”, additionally other use cases might also be addressed. Starting from Release 18, it is very likely that companies will propose a large variety of use cases and applications on ML in the gNB and UE. The goal is to explore the benefits of augmenting the air-interface with features enabling improved support of AI/ML-based algorithms for enhanced performance and/or reduced complexity/overhead. The enhanced performance depends on the considered use cases and could be, e.g., improved throughput, robustness, accuracy or reliability, etc. The goal is that sufficient use cases will be considered to enable the identification of a common AI/ML framework, including functional requirements of AI/ML architecture, which could be used in subsequent projects. The study should also identify areas where AI/ML could improve the performance of air-interface functions. Specification impact will be assessed in order to improve the overall understanding of what would be required to enable AI/ML techniques for the air interface.

In relation thereto, two-sided models are outlined in more detail for reasons of understandability in the following.

Regarding two-sided models, it shall be noted that in RAN #109-e meeting, RAN1 made a working assumption on AI/ML model terminologies.

A working assumption is to include the following into a working list of terminologies (see Table 1) to be used for RAN1 AI/ML air interface SI discussion. The description of the terminologies may be further refined as the study progresses and new terminologies may be added as the study progresses.

TABLE 1
Working list of terminologies

| Terminology | Description |
|---|---|
| Data collection | A process of collecting data by the network nodes, |
| | management entity, or UE for the purpose of AI/ML model |
| | training, data analytics and inference |
| AI/ML Model | A data driven algorithm that applies AI/ML techniques to |
| | generate a set of outputs based on a set of inputs. |
| AI/ML model training | A process to train an AI/ML Model [by learning the |
| | input/output relationship] in a data driven manner and |
| | obtain the trained AI/ML Model for inference |
| AI/ML model Inference | A process of using a trained AI/ML model to produce a set |
| | of outputs based on a set of inputs |
| AI/ML model validation | A subprocess of training, to evaluate the quality of an |
| | AI/ML model using a dataset different from one used for |
| | model training, that helps selecting model parameters that |
| | generalize beyond the dataset used for model training. |
| AI/ML model testing | A subprocess of training, to evaluate the performance of a |
| | final AI/ML model using a dataset different from one used |
| | for model training and validation. Differently from AI/ML |
| | model validation, testing does not assume subsequent |
| | tuning of the model. |
| UE-side (AI/ML) model | An AI/ML Model whose inference is performed entirely at |
| | the UE |
| Network-side (AI/ML) | An AI/ML Model whose inference is performed entirely at |
| model | the network |
| One-sided (AI/ML) model | A UE-side (AI/ML) model or a Network-side (AI/ML) model |
| Two-sided (AI/ML) model | A paired AI/ML Model(s) over which joint inference is |
| | performed, where joint inference comprises AI/ML |
| | Inference whose inference is performed jointly across the |
| | UE and the network, i.e, the first part of inference is firstly |
| | performed by UE and then the remaining part is performed |
| | by gNB, or vice versa. |
| AI/ML model transfer | Delivery of an AI/ML model over the air interface, either |
| | parameters of a model structure known at the receiving |
| | end or a new model with parameters. Delivery may contain |
| | a full model or a partial model. |
| Model download | Model transfer from the network to UE |
| Model upload | Model transfer from UE to the network |
| Federated learning / | A machine learning technique that trains an AI/ML model |
| federated training | across multiple decentralized edge nodes (e.g., UEs, |
| | gNBs) each performing local model training using local |
| | data samples. The technique requires multiple interactions |
| | of the model, but no exchange of local data samples. |
| Offline field data | The data collected from field and used for offline training of |
| | the AI/ML model |
| Online field data | The data collected from field and used for online training of |
| | the AI/ML model |
| Model monitoring | A procedure that monitors the inference performance of the |
| | AI/ML model |
| Supervised learning | A process of training a model from input and its |
| | corresponding labels. |
| Unsupervised learning | A process of training a model without labelled data. |
| Semi-supervised learning | A process of training a model with a mix of labelled data |
| | and unlabelled data |
| Reinforcement Learning | A process of training an AI/ML model from input (a.k.a. |
| (RL) | state) and a feedback signal (a.k.a. reward) resulting from |
| | the model's output (a.k.a. action) in an environment the |
| | model is interacting with. |
| Model activation | enable an AI/ML model for a specific function |
| Model deactivation | disable an AI/ML model for a specific function |
| Model switching | Deactivating a currently active AI/ML model and activating |
| | a different AI/ML model for a specific function |

The two-sided model is considered mainly for CSI compression, where RAN1 #109-e and RAN1 #110 meeting made the following agreements (i) to (iii).
(i) Namely, for the evaluation of the AI/ML based CSI compression sub use cases, a two-sided model is considered as a starting point, including an AI/ML-based CSI generation part to generate the CSI feedback information and an AI/ML-based CSI reconstruction part, which is used to reconstruct the CSI from the received CSI feedback information.
   At least for inference, the CSI generation part is located at the UE side, and the CSI reconstruction part is located at the gNB side.
(ii) Further, spatial-frequency domain CSI compression using two-sided AI model is selected as one representative sub use case.
   It shall be noted that study of other sub use cases is not precluded.
   It shall further be noted that all pre-processing/post-processing, quantization/de-quantization are within the scope of the sub use case.
(ii) Moreover, in CSI compression using two-sided model use case, the following AI/ML model training collaborations will be further studied:
   Type 1: Joint training of the two-sided model at a single side/entity, e.g., UE-sided or Network-sided.
   Type 2: Joint training of the two-sided model at network side and UE side, respectively.
   Type 3: Separate training at network side and UE side, where the UE-side CSI generation part and the network-side CSI reconstruction part are trained by UE side and network side, respectively.
It shall be noted that joint training means the generation model and reconstruction model should be trained in the same loop for forward propagation and backward propagation.
   Joint training could be done both at single node or across multiple nodes (e.g., through gradient exchange between nodes).
   It shall further be noted that separate training includes sequential training starting with UE side training, or sequential training starting with NW side training, or parallel training at UE and NW
   Other collaboration types are not excluded.

Overall, the two-sided model creates certain challenges, and careful considerations on how such models can be used in the NR framework are needed. Hence, in view thereof, addressing at least some these problems related to such two-sided models is needed.

It is therefore an object of the present specification to improve the prior art.

The following meanings for the abbreviations used in this specification apply:
2G Second Generation
3G Third Generation
3GPP 3^{rd} Generation Partnership Project
3GGP2 3^{rd} Generation Partnership Project 2
4G Fourth Generation
5G Fifth Generation
6G Sixth Generation
AI Artificial Intelligence
AN Access Node
AP Access Point
BS Base Station
CDMA Code Division Multiple Access
CNN Convolutional Neural Network
CSI Channel State Information
DCI Downlink Control Information
DL Downlink
DSL Digital Subscriber Line
EDGE Enhanced Data Rates for Global Evolution
EEPROM Electrically Erasable Programmable Read-only Memory
eNB Evolved Node B
ETSI European Telecommunications Standards Institute
gNB Next Generation Node B
GPRS General Packet Radio System
GSM Global System for Mobile communications
IEEE Institute of Electrical and Electronics Engineers
ISDN Integrated Services Digital Network
ITU International Telecommunication Union
KPI Key Performance Indicator
LTE Long Term Evolution
LTE-A Long Term Evolution-Advanced
MAC CE Medium Access Control Control Element
MANETs Mobile Ad-Hoc Networks
MIMO Multiple-Input and Multiple-Output
ML Machine Learning
NR New Radio
NB Node B
NN Neural Network
RAM Random Access Memory
RAN Radio Access Network
RB Residual Block
ROM Read Only Memory
RS Reference Signal
Rx Receiver
SSB Synchronized Signal Block
TISPAN Telecoms & Internet converged Services & Protocols for Advanced Networks
TRP Transmission Point
Tx Transmitter
UE User Equipment
UL Uplink
UMTS Universal Mobile Telecommunications System
UWB Ultra-Wideband
WCDMA Wideband Code Division Multiple Access
WiMAX Worldwide Interoperability for Microwave Access
WLAN Wireless Local Area Network

### SUMMARY

It is an objective of various examples of embodiments of the present disclosure to improve the prior art. Hence, at least some examples of embodiments of the present disclosure aim at addressing at least part of the above-outlined issues and/or problems and drawbacks.

Various aspects of examples of embodiments of the present disclosure are set out in the appended claims and relate to methods, apparatuses and computer program products relating to UE initiated model-updates for a two-sided AI/ML model.

The objective is achieved by the methods, apparatuses and non-transitory storage media as specified in the appended claims. Advantageous further developments are set out in respective dependent claims.

Any one of the aspects mentioned according to the appended claims enables UE initiated model-updates for a two-sided AI/ML model, thereby allowing to solve at least part of the problems and drawbacks as identified/derivable from above. Thus, improvement is achieved by methods, apparatuses and computer program products enabling UE initiated model-updates for a two-sided AI/ML model.

In more detail, the disclosure according to the present specification allows i.a. to ensure that model inference is consistent across nodes that are involved in a two-sided model inference.

Further advantages become apparent from the following detailed description.

### BRIEF DESCRIPTION OF THE DRAWINGS

Some embodiments of the present disclosure are described below, by way of example only, with reference to the accompanying drawings, in which:

FIG. 1 shows an example for training of a two-sided model;

FIG. 2 shows an example for ML model or dataset updates at the UE side of a two-sided model;

FIG. 3 shows an example for ML model or dataset updates at the network side of a two-sided model;

FIG. 4 shows a message sequence for a two-sided ML model update scenario according to various examples of embodiments;

FIG. 5 shows a flowchart illustrating steps corresponding to a method according to various examples of embodiments;

FIG. 6 shows a flowchart illustrating steps corresponding to a method according to various examples of embodiments;

FIG. 7 shows a block diagram illustrating an apparatus according to various examples of embodiments; and

FIG. 8 shows a block diagram illustrating an apparatus according to various examples of embodiments.

### DESCRIPTION OF EMBODIMENTS

Basically, for properly establishing and handling a communication between two or more end points (e.g. communication stations or elements or functions, such as terminal devices, user equipments (UEs), or other communication network elements, a database, a server, host etc.), one or more network elements or functions (e.g. virtualized network functions), such as communication network control elements or functions, for example access network elements like access points (APs), radio base stations (BSs), relay stations, eNBs, gNBs etc., and core network elements or functions, for example control nodes, support nodes, service nodes, gateways, user plane functions, access and mobility functions etc., may be involved, which may belong to one communication network system or different communication network systems.

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is obvious for a person skilled in the art that the embodiments may also be applied to other kinds of communication networks like 4G and/or LTE (and even 6G) where mobile communication principles are integrated, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network or datacenter networking.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit (CU), which controls a respective coverage area or cell(s) and with which one or more communication stations such as communication elements or functions, like user devices (e.g. customer devices), mobile devices, or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, (core) network elements or network functions ((core) network control elements or network functions, (core) network management elements or network functions), such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a mobile device, a terminal device, control elements or functions, such as access network elements, like a base station (BS), an eNB/gNB, a radio network controller, a core network control element or function, such as a gateway element, or other network elements or functions, as described herein, (core) network management element or function and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

Moreover, with regard to two-sided models as introduced above, several challenges need to be addressed. In view thereof, potential problems are outlined in the following in more detail.

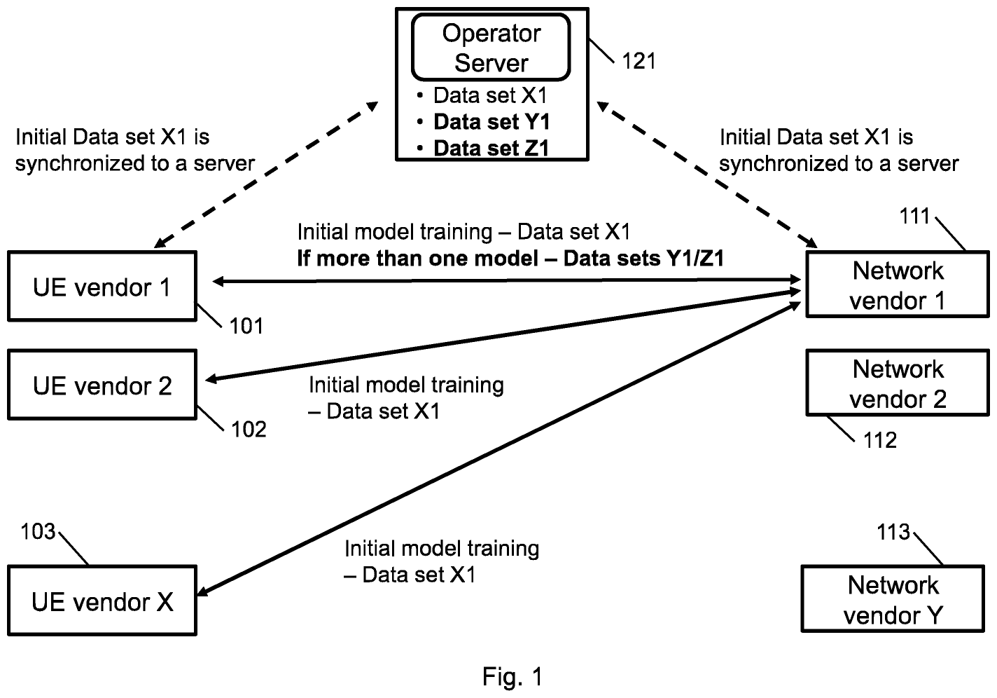

Namely, for a two-sided model (terminology definition: a paired AI/ML Model(s) over which joint inference is performed, where joint inference comprises AI/ML inference whose inference is performed jointly across the UE and the network, i.e., the first part of inference is firstly performed by UE and then the remaining part is performed by gNB, or vice versa), as the joint inference is required at the UE and network-sided parts, a careful consideration on model training and model updating is required to make sure inference performance is kept in a good level. To see how the two-sided model training is done in a more practical set-up, it is herewith referred to FIG. 1, which sets the background for the problem to be solved according to the present specification.

With reference to FIG. 1, an initial set-up (training of two-sided model) may be done via offline-engineering (i.e., may not be fully related to standardization) where network and UE vendors develop/train corresponding network-sided part and UE-sided part of the two-sided ML model (e.g., encoder and decoder) via joint/separate model training. The data set used for the model training may be stored in an operator server so that any updates can be accessible to all parties. The exact format used for the data set shall be known or coordinated by the network and UE sides.

According to FIG. 1, the following steps are considered. Model training is done based on offline engineering between UE vendors (101; 102; 103) and network vendors (111; 112; 113). Hence, a joint or separate training may be applied depending on the UE vendor. Additionally and/or alternatively, there may be multiple models each corresponding to a different configuration/scenario and/or data sets (to support generalization).

Furthermore, a training data set(s) (e.g. for CSI compression use case this data set could be {e(H), H} for a given scenario/configuration. Here, H may be the channel and e(H) may be the compressed output of the encoder (channel compression) for H) may be updated and accessible by both UE and network vendors. In another variant, the training data set(s) may be updated only by one party (e.g., UE vendor), and can be accessible by the network vendors. Accordingly, this may allow the training of newly available UE nodes and network nodes. Also, a neutral party (Operator (121)), UE vendor, or network vendor may support storing the data sets.

Moreover, with a set-up assumed in FIG. 1, it is understandable that model training and deployment (i.e., taking a trained model into account) may happen without any model transfers and other complicated involvements of air-interface that saves air interface resources as it is understood that model transfer typically may take several MB's worth of data and UE may not always be in the position to receive such a volume of data (e.g., due to coverage).

However, in general, it is hard to assume that the deployed ML model can work without any further updates over time, and a similar statement will be valid for a two-sided model. The two-sided model used by the UE and gNB may also be required to undergo updates/fine-tuning with newly available data in order to pursue good performance with changing radio conditions.

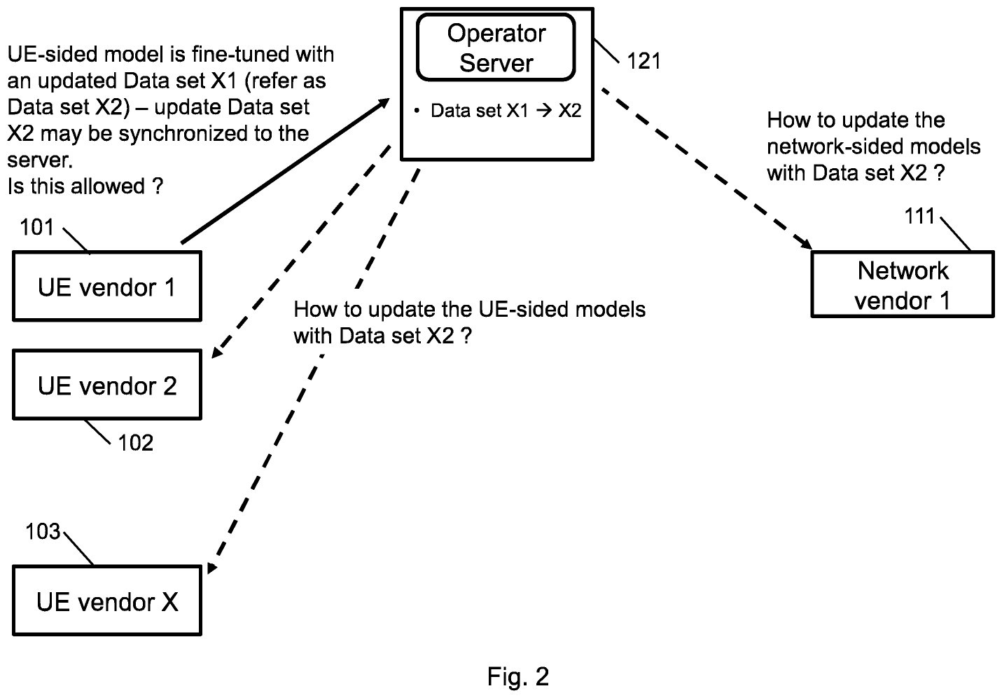

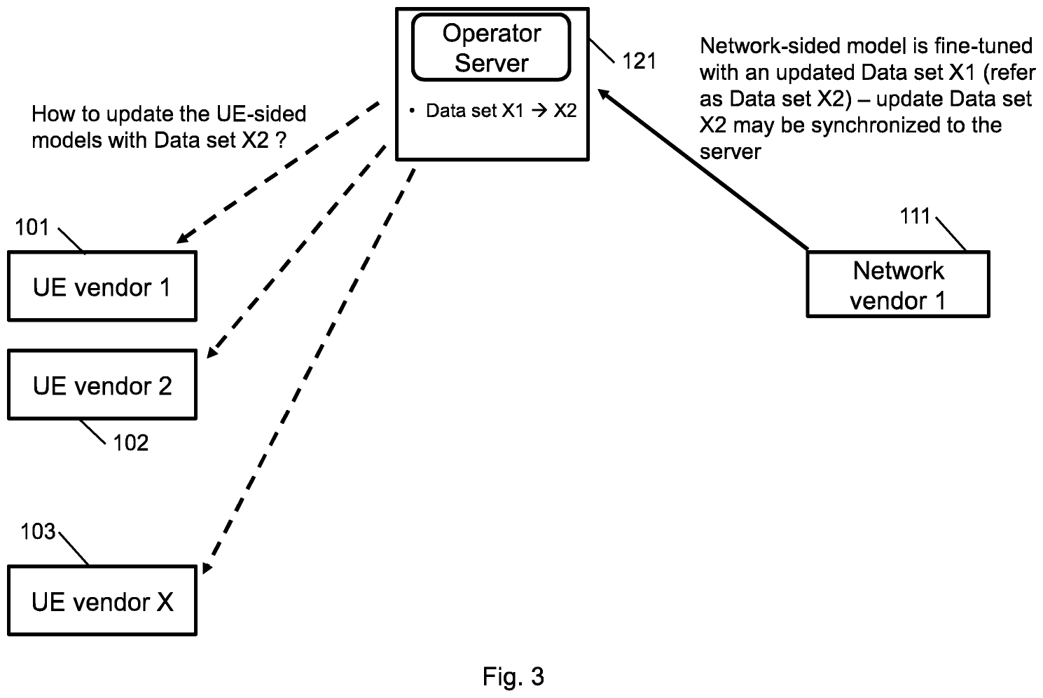

Accordingly, with reference to FIGS. 2 and 3, the following two cases can be expected for model updates for a two-sided model, wherein FIG. 2 shows an example for ML model or dataset updates at the UE side of a two-sided model, and FIG. 3 shows an example for ML model or dataset updates at the network side of a two-sided model.
1. UE-sided part of the two-sided model (e.g., encoder part corresponding to CSI compression) may be updated based on certain structural/architectural changes to the ML model and/or changes due to availability/updated data sets. FIG. 2 shows an example, where UE does the model updates with newly available data and updates the Data set as Data Set X2 in the remote server. Here, as the network is using a model that is not trained with the Data Set X2, the two-sided model may create incompatibility and performance issues (e.g., failure of receiving the information encoded by the UE using the updated model ultimately leading to connection failure).
2. Network-sided part of the two-model (e.g., the decoder part corresponding to CSI compression) may be updated based on certain structural/architectural changes to the ML model and/or changes due to availability/updated data sets. FIG. 3 shows an example, where the network does the model updates with newly available data (update to the server refer as Data set X2). Here, as UE is using a model that is not trained with the Data Set X2, the two-sided model may create incompatibility and performance issues (e.g., failure of receiving the information encoded by the UE using the updated model ultimately leading to connection failure).

In view of the above, the present specification propose a NR framework to address the above-outlined issues, particularly the issues highlighted in FIG. 2, where the UE does the model update. Hence, the present specification addresses the following two key issues.

Namely, first, how a UE updates the ML model when the underlying data set changes (e.g., informing the network) and, second, how the network and the UE communicate to perform the ML model update without sacrificing performance and latency.

Thus, the present specification allows to achieve the following advantages by enabling a UE to update the ML model when the underlying data set changes and by enabling a communication between the network and the UE, which allows to perform the ML model update without sacrificing performance and latency.

In the following, examples of embodiments are outlined, which allow to solve at least part of the above-outlined problems and/or which allow to achieve at least part of the above-outlined advantages.

According to at least some examples of embodiments, when a two-sided model is used for joint model inference at the UE and network side for a given feature/sub-use case/use case, and if the model is updated or required to be updated at the UE, the following procedure may be followed to ensure the model inference is consistent across nodes that are involved in the two-sided model inference.

Namely, a UE is configured (via e.g. higher-layer) with parameters that enable/allow a UE triggered/initiated UL transmission in an event of any change/update/fine-tuning is required at the UE at least for the UE part of the two-sided model.

The parameters that enable/allow the UE-triggered UL transmission may contain resource(s) to be used in UL transmission, format to be used in the UL transmission, and/or information to be carried in the UL transmission. For example, the UE triggered UL transmission may be a scheduling request with a dedicated PUCCH resource associated with model update indication. In another example, the UE may be configured to use a dedicated MAC-CE command in the UL transmission such that the UE can indicate some information about the model update such as whether the model update indication is for a model update or approval for a model update, the version number of the used data set to identify by the network, and other. Regarding the information to be carried in the UL transmission, this information could be a minimal level information that can be carried on at least one of the following, where more details/information may later/subsequently be requested by the network (by use of e.g. a further and/or scheduled UL transmission as outlined below in more detail) in case that the network may need additional details/information:
information related to the data set used/relevant for model update (any related version number of the used data set to identify by the network);
information related to inference complexity/latency with the updated UE part of the two-sided model;
information related to UE part model configuration or output changes (output dimensions, capabilities);
any required model update duration (inference may not be applied for a time duration X until the model gets fully updated) and/or the possibility of applying the older model during any model update duration; or
any other related parameters associated with the two-sided model.

The UE triggered/initiated model update may indicate a request for a model update or approval for a model update at the UE. Request for model update may mean that UE is still capable of performing joint inference based on an earlier version of the model, but the UE prefers to update the model based on the newly available data set. The UE indicating the request may represent a first scenario. Approval for model update may apply when the UE changes the model from an earlier version of the model to a newer version without any pre-approval from the network, e.g., update the model solely applied at the UE, and UE indicates the update to the network prior using it for inference. The UE indicating the approval may represent a second scenario, where the UE does model updates without consulting e.g. the gNB, but just indicating the update after the update is done.

Further, the UE determines that the model used at the UE may require to be updated (e.g., based on newly available data). The relevant data set used for the model update/fine-tuning may be synchronized to a remote server (which is accessible to the network). In the secondary scenario (when approval applies), the UE may update the UE part of the two-sided model with newly available data.

Furthermore, the UE triggers/initiates UL transmission based on the received configuration according to the parameters that enable/allow UL transmission and indicates the request for model update. In the secondary scenario (when approval applies), the UE may further indicate that the UE part of the two-sided model is updated.

Moreover, based on the received UL transmission indicating a request (or approval) for a model update, the network may schedule further UL transmission (e.g., PUSCH scheduled by a UL DCI), where the UL transmission may carry further information related to the requested model update. The further information may contain,
information related to the data set used/relevant for model update (any related version number of the used data set to identify by the network)
information related to inference complexity/latency with the updated UE part of the two-sided model
information related to UE part model configuration or output changes (output dimensions, capabilities)
any required model update duration (inference may not be applied for a time duration X until the model gets fully updated) and/or the possibility of applying the older model during any model update duration
any other related parameters associated with the two-sided model

According to the scheduled UL transmission, the UE may transmit the UL transmission providing more information about the request (or the approval) for model update

Based on the received further information related to the requested model update, the gNB may consider one or more of the following operations,
Fetch a data set from a remote server and see the requirement of model update at the network side,
Indicate the UE that the model can be updated or not (when the request for the model update is sent),
Reject the approval for model update (when the approval for the model update is sent),
Pause the use of the two-sided model during the model update duration (when the request for the model update is sent),
Indicate the UE to continue with using the older version of UE-part of the two-sided model
Configure necessary parameters to support joint inference with the updated UE-part of the two-sided model
Trigger model update at other nodes (other UEs) and network node based on newly available data

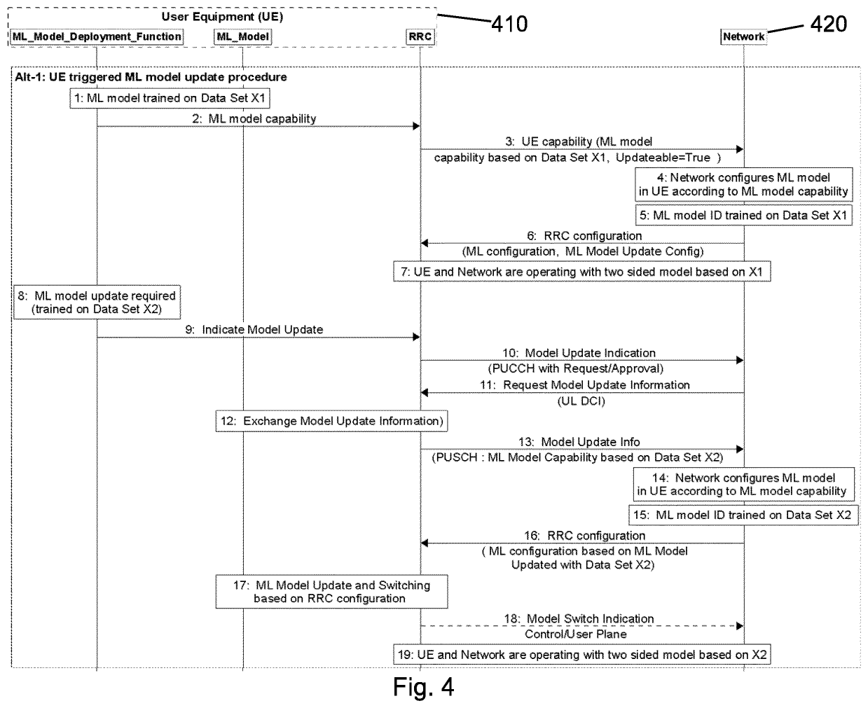

Referring now to FIG. 4, FIG. 4 shows a message sequence for a two-sided ML model update scenario according to various examples of embodiments. In the following, the sequence according to FIG. 4 is outlined in detail.

Step 1-5: It may be assumed that the UE 410 has an ML model that is trained using the data set X1 and it has sent the ML model related capabilities to the network 420 in Step 2 and 3. The ML model capability in Step 3 may indicate for example that the ML model is trained in the UE based on a Data Set X1 (X1 could be a global or vendor specific identifier identifying the training/validation data batch) but also the ML model can be updated. As it is a two-sided model, the network 420 could also train such a model retrieving the Data Set X1 from the operator's server as described above. As the ML model is updateable, the network prepares a ML model update configuration in the subsequent Step 6.

Step 6: The network 420 configures the UE 410 to operate with the ML configuration corresponding to this trained model using Data Set X1. As part of the ML Model Update Config in one possible implementation the network 420 configures an RRC ASN.1 information element (i.e., configuration parameter) that enables the UE 410 to trigger an UL transmission (e.g. first UL transmission) in event of any model update/change. The parameters that enable/allow the UE-triggered UL transmission may contain resource(s) to be used in UL transmission, format to be used in the UL transmission, and information to be carried in the UL transmission. For example, the UE triggered UL transmission may be a scheduling request with a dedicated PUCCH resource associated with model update indication.

Step 7: The network 420 and UE 410 are aligned to operate on ML model based on the Data Set X1.

Step 8: At a later point of time, the ML model deployment function triggers a ML model update need.
The UE 410 determines that the model used at the UE 410 may require to be updated (e.g., based on newly available data)
The relevant data set used for the model update/fine-tuning may be synchronized to a remote server (which is accessible to the network).
In the secondary variant (when approval applies), the UE 410 may update the UE part of the two-sided model with newly available data.

Step 9, 10: This results in a ML model update request to the RRC layer in the UE 410 that further triggers the message in Step 10. The UE triggered/initiated model update may indicate a request for a model update or approval for a model update at the UE 410. Request for model update may mean that UE 410 is still capable of performing joint inference based on an earlier version of the model, but the UE 410 prefers to update the model based on the newly available data set. In this case, this is the Data Set ID X2. This may represent the above-mentioned first scenario. Approval for model update may apply when the UE 410 changes the model from an earlier version of the model to a newer version without any pre-approval from the network 420, e.g., update the model solely applied at the UE 410, and the UE 410 indicates the update to the network 420 prior using it for inference. This may represent the above-mentioned second scenario.

Step 11: Based on the received UL transmission indicating a request (or approval) for a model update, the network 420 may schedule further UL transmission (e.g., PUSCH scheduled by a UL DCI), where the UL transmission (e.g. second UL transmission) may carry further information related to the requested model update. The further information may contain,
information related to the data set used/relevant for model update (any related version number of the used data set to identify by the network)
information related to inference complexity/latency with the updated UE part of the two-sided model
information related to UE part model output changes (dimensions, capabilities)
any required model update duration (inference may not be applied for a time duration X until the model gets fully updated) and/or the possibility of applying the older model during any model update duration any other related parameters associated with the two-sided model

Step 12, 13: According to the scheduled UL transmission, the UE 410 may transmit the UL transmission providing more information about the request (or the approval) for model update. In a particular implementation, the UE 410 sends the Data Set ID here X2 as the updated data set, which should be used for the ML model training.

Step 14-17: Based on the received further information related to the requested model update. The gNB may consider one or more of the following, indicating this in the RRC configuration of how the UE 410 should perform the ML update in the two-sided case (information provided to the UE 410 based on e.g. the gNB executing one of the below-outlined processes may be understood to represent update information, wherein the UE may use such update information to know how to proceed further in view of e.g. updating (or not updating) the UE part of the two-sided model):
Fetch the data set from the remote server and see the requirement of model update at the network side,
Indicate the UE 410 that the model can be updated or not (when the request for the model update is sent),
Reject the approval for model update (when the approval for the model update is sent),
Pause the use of the two-sided model during the model update duration (when the request for the model update is sent),
Indicate the UE 410 to continue with using the older version of UE-part of the two-sided model
Trigger model update at other nodes (other UEs) and network node based on newly available data

Also based on the information provided in Step 11, the network 420 provides a RRC configuration comprising the update ML model configuration (e.g., updated dimensions). In addition, the network 420 also configures how the UE 410 should switch during the model update process. For example, a switching may be defined by a timer or an execution condition (i.e., immediately upon ML model update complete or generate X samples of output and then switch)

Step 18-19: The UE 410 may indicate to the network 420 that it has successfully switched to the updated ML model in Step 18 by either a control plane (RRC) or user plane (e.g., in the payload of an uplink transmission e.g., a CSI report). In Step 19, both network 420 and UE 410 have switched to the updated ML model.

In the following, further examples of embodiments are described in relation to the above described methods and/or apparatuses.

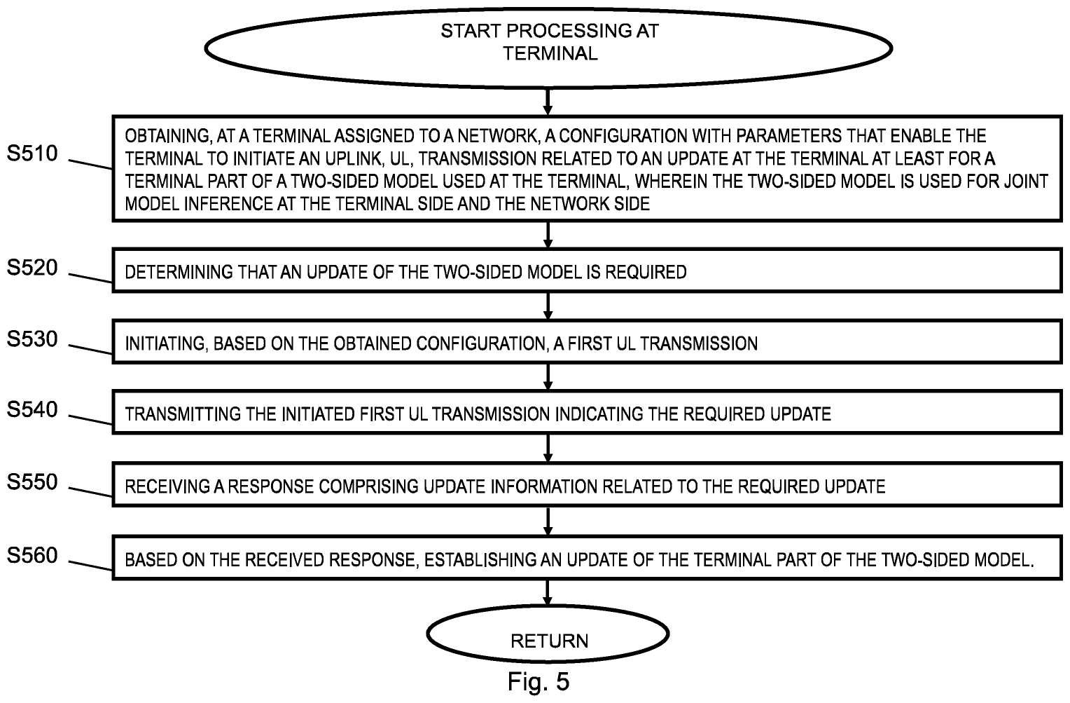

Referring now to FIG. 5, there is shown a flowchart illustrating steps corresponding to a method according to various examples of embodiments. Such method may comprise at least some of the processes and/or steps as outlined above with reference to FIG. 4.

In particular, according to FIG. 5, in S510, the method comprises obtaining, at a terminal assigned to a network, a configuration with parameters that enable the terminal to initiate an uplink, UL, transmission related to an update at the terminal at least for a terminal part of a two-sided model used at the terminal, wherein the two-sided model is used for joint model inference at the terminal side and the network side.

It shall be noted that the method may be applied at an access network entity or function of the network to which the terminal is assigned. Such network may represent such network 420 as described with reference to FIG. 4. Moreover, such access network entity or function may e.g. represent a gNB, like such gNB as described with reference to FIG. 4. The terminal communicating with the network may be represented by the terminal communicating with the gNB. Furthermore, such terminal as mentioned herewith may represent such UE 410 as described with reference to FIG. 4. Still further, such step S510 of FIG. 5 may correspond to at least part of such step 6 as outlined above with reference to FIG. 4. Also, the two-sided model as mentioned in S510 may correspond to such two-sided model as outlined above with reference to FIG. 4.

Further, in S520, the method comprises determining that an update of the two-sided model is required. Such step S510 of FIG. 5 may correspond to at least part of such step 8 as outlined above with reference to FIG. 4.

Additionally, in S530, the method comprises initiating, based on the obtained configuration, a first UL transmission. Such step S530 of FIG. 5 may correspond to at least part of such steps 9 and 10 as outlined above with reference to FIG. 4.

It shall be noted that the “initiating” may also be understood to represent a “triggering”.

Further, in S540, the method comprises transmitting the initiated first UL transmission indicating the required update. Such step S540 of FIG. 5 may correspond to at least part of such steps 9 and 10 as outlined above with reference to FIG. 4.

Additionally, in S550, the method comprises receiving a response comprising update information related to the required update. Such step S550 of FIG. 5 may correspond to at least part of such steps 14 to 17 as outlined above with reference to FIG. 4.

Further, in S560, the method comprises, based on the received response, establishing an update of the terminal part of the two-sided model.

It shall be noted that establishing the update may comprise updating the two-sided model and using an already updated two-sided mode for which an approval has been obtained. Hence, the term “establishing” comprises both of the above-outlined scenarios, the first scenario, where the updating is performed based on a response, and the second scenario, where approval for an already updated two-sided model is obtained. Such step S560 of FIG. 5 may correspond to at least part of such steps 14 to 17 as outlined above with reference to FIG. 4.

Moreover, according to at least some examples of embodiments, the first UL transmission may comprise a request for an update of the two-sided model. Such UL transmission may correspond to the above-outlined first scenario.

Furthermore, according to various examples of embodiments, the method may further comprise updating the terminal part of the two-sided model based on a result obtained from the determining, wherein the first UL transmission comprises an approval for the updated terminal part of the two-sided model, and wherein the establishing comprises establishing the approved updated terminal part.

Additionally, according to various examples of embodiments, the directly-above mentioned updating may comprise obtaining, from a remote server, a second data set usable by the two-sided model newer than a first data set currently used by the two-sided model; and updating the terminal part of the two-sided model based on the obtained second data set.

Optionally, according to at least some examples of embodiments, the determining may further comprise determining that a second data set usable by the two-sided model newer than a first data set currently used by the two-sided model is provided at a remote server.

A (older/newer) data set may also be understood to represent a (older/newer) version of the (terminal part and/or network part of the) two-sided model.

Further, according to various examples of embodiments, the parameters may contain at least one of: radio resources to be used in the first UL transmission, a data format and/or transmission format to be used in the first UL transmission, or information to be carried in the first UL transmission. Wherein the information comprises at least one of: information related to a data set useable and/or used to update the two-sided model, information related to inference complexity related to the terminal part and/or updated terminal part of the two-sided model, information related to inference latency related to the terminal part and/or updated terminal part of the two-sided model, information related to a configuration of the terminal part and/or updated terminal part of the two-sided model, information related to output changes of the two-sided model associated with the terminal part and/or updated terminal part of the two-sided model, a duration required to update the terminal part of the two-sided model, or a possibility to apply the terminal part and/or updated terminal part of the two-sided model during an update duration for updating the two-sided model.

Moreover, according to at least some examples of embodiments, wherein the method may further comprise, responsive to the transmitted first UL transmission, receiving a scheduling for a second UL transmission; and transmitting the scheduled second UL transmission comprising at least one of the following information related to the required update: information related to a data set useable and/or used to update the two-sided model, information related to inference complexity related to the terminal part and/or updated terminal part of the two-sided model, information related to inference latency related to the terminal part and/or updated terminal part of the two-sided model, information related to a configuration of the terminal part and/or updated terminal part of the two-sided model, information related to output changes of the two-sided model associated with the terminal part and/or updated terminal part of the two-sided model, a duration required to update the terminal part of the two-sided model, or a possibility to apply the terminal part and/or updated terminal part of the two-sided model during an update duration for updating the two-sided model. This may correspond to at least part of such steps 11 to 13 as outlined above with reference to FIG. 4.

Furthermore, according to various examples of embodiments, wherein the method may further comprise receiving the response comprising the update information responsive to the transmitted first or second UL transmission, wherein the update information comprises at least one of the following: if the first UL transmission comprises the request, an indication about whether or not the terminal part of the two-sided model is updateable, if the first UL transmission comprises the request, an indication about whether or not to pause use of the two-sided model during an update duration for updating the two-sided model, if the first UL transmission comprises the request, a configuration comprising an update to the terminal part of the two-sided model, if the first UL transmission comprises the approval, an indication about whether or not the approval is rejected, a configuration about how to switch in an update duration for updating the two-sided model, or an indication to continue with using the two-sided model without updating the two-sided model.

Additionally, according to various examples of embodiments, wherein the method may further comprise, based on the received response, switching to the updated two-sided model; and indicating the switch to the updated two-sided model by either a control plane or user plane. This may correspond to at least part of such steps 18 and 19 as outlined above with reference to FIG. 4.

Optionally, according to at least some examples of embodiments, the two-sided model may be a two-sided AI/ML model.

The above-outlined solution allow for terminal (UE, respectively) initiated model-updates for two-sided AI/MI model. Therefore, the above-outlined solution is advantageous in that it enables for efficient and/or secure and/or robust and/or failure resistant and/or flexible terminal (UE, respectively) initiated model-updates for two-sided AI/MI model.

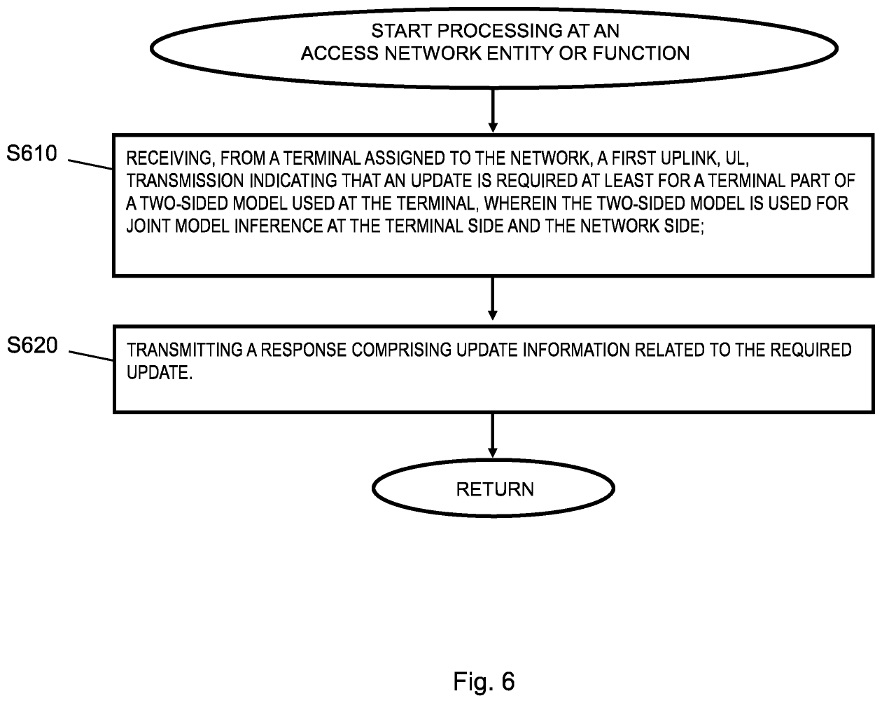

Referring now to FIG. 6, FIG. 6 shows a flowchart illustrating steps corresponding to a method according to various examples of embodiments. Such method may comprise at least some of the processes and/or steps as outlined above with reference to FIG. 4.

In particular, according to FIG. 6, in S610, the method comprises, at an access network entity or function of a network, receiving, from a terminal assigned to the network, a first uplink, UL, transmission indicating that an update is required at least for a terminal part of a two-sided model used at the terminal, wherein the two-sided model is used for joint model inference at the terminal side and the network side.

Such step S610 of FIG. 6 may correspond to at least part of such steps 9 and 10 as outlined above with reference to FIG. 4.

Moreover, according to FIG. 6, in 620, the method comprises transmitting a response comprising update information related to the required update.

Such step S620 of FIG. 6 may correspond to at least part of such steps 14 to 17 as outlined above with reference to FIG. 4.

Further, according to various examples of embodiments, the method may further comprise providing to the terminal a configuration with parameters that enable the terminal to initiate the first UL transmission, wherein the parameters contain at least one of radio resources to be used in the first UL transmission, a data format and/or transmission format to be used in the first UL transmission, or information to be carried in the first UL transmission. Wherein the information comprises at least one of information related to a data set useable and/or used to update the two-sided model, information related to inference complexity related to the terminal part and/or an updated terminal part of the two-sided model, information related to inference latency related to the terminal part and/or an updated terminal part of the two-sided model, information related to a configuration of the terminal part and/or an updated terminal part of the two-sided model, information related to output changes of the two-sided model associated with the terminal part and/or an updated terminal part of the two-sided model, a duration required to update the terminal part of the two-sided model, or a possibility to apply the terminal part and/or an updated terminal part of the two-sided model during an update duration for updating the two-sided model.

Moreover, according to at least some examples of embodiments, wherein the method may further comprise responsive to the received first UL transmission, scheduling a second UL transmission; and receiving the scheduled second UL transmission comprising at least one of the following information related to the required update: information related to a data set useable and/or used to update the two-sided model, information related to inference complexity related to the terminal part and/or an updated terminal part of the two-sided model, information related to inference latency related to the terminal part and/or an updated terminal part of the two-sided model, information related to a configuration of the terminal part and/or an updated terminal part of the two-sided model, information related to output changes of the two-sided model associated with the terminal part and/or an updated terminal part of the two-sided model, a duration required to update the terminal part of the two-sided model, or a possibility to apply the terminal part and/or an updated terminal part of the two-sided model during an update duration for updating the two-sided model.

Furthermore, according to various examples of embodiments, the method may further comprise at least one of the following responsive to the received first or second UL transmission: obtaining a data set to update the two-sided model from a remote server and obtaining requirements to update the network side of the two-sided model, updating the network side of the two-sided model, if the first UL transmission comprises a request for an update of the two-sided model, indicating to the terminal about whether or not the terminal part of the two-sided model is updateable, if the first UL transmission comprises an approval for an updated terminal part of the two-sided model, determining about whether or not to reject the approval, if the first UL transmission comprises a request for an update of the two-sided model, pausing use of the two-sided model during an update duration for updating the two-sided model, indicating to the terminal to continue with using the two-sided model without updating the two-sided model, configuring parameters related to the two-sided model in order to support joint inference with an updated terminal part of the two-sided model, or triggering an update of the two-sided model at another access network entity or function and/or at another terminal.

Additionally, according to various examples of embodiments, the method may further comprise receiving an indication that the terminal has switched to the updated two-sided model by either a control plane or user plane.

The above-outlined solution allow for terminal (UE, respectively) initiated model-updates for two-sided AI/MI model. Therefore, the above-outlined solution is advantageous in that it enables for efficient and/or secure and/or robust and/or failure resistant and/or flexible terminal (UE, respectively) initiated model-updates for two-sided AI/MI model.

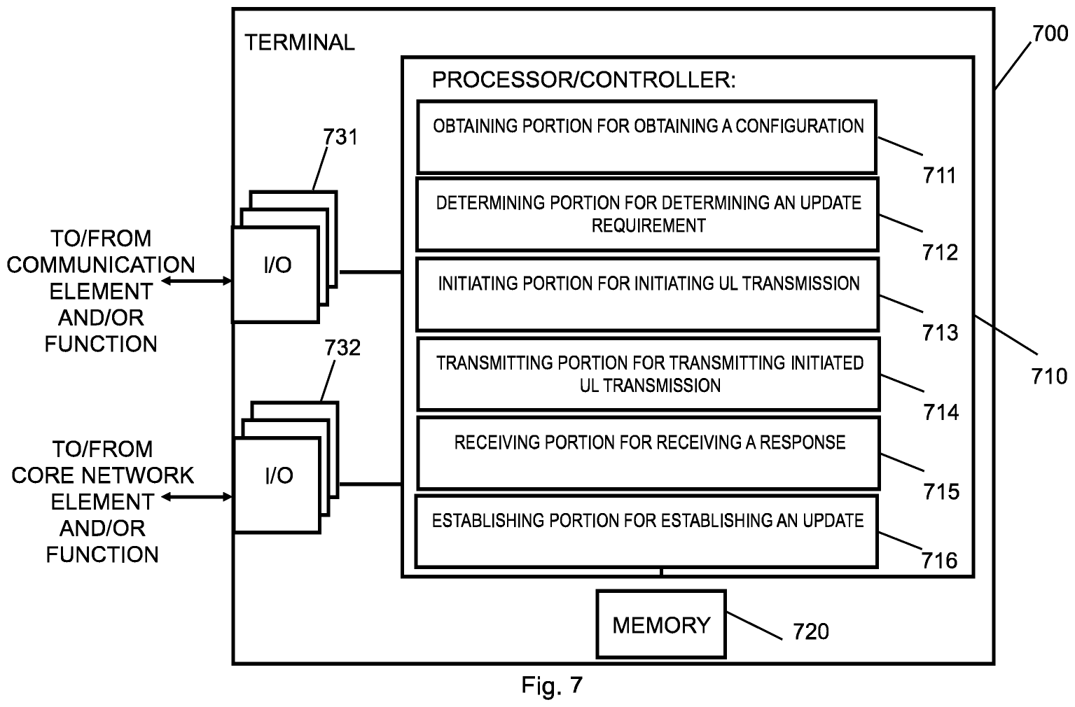

Referring now to FIG. 7, FIG. 7 shows a block diagram illustrating an apparatus according to various examples of embodiments.

Specifically, FIG. 7 shows a block diagram illustrating an apparatus 700, which may represent a terminal or UE, like e.g. such UE 410 as outlined above with reference to FIG. 4, according to various examples of embodiments, which may participate in terminal/UE initiated model-updates for a two-sided AI/MI model. Furthermore, even though reference is made to a terminal, the terminal may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 700 shown in FIG. 7 may include a processing circuitry, a processing function, a control unit or a processor 710, such as a CPU or the like, which is suitable to enable terminal/UE initiated model-updates for a two-sided AI/MI model. The processor 710 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 731 and 732 denote input/output (I/O) units or functions (interfaces) connected to the processor or processing function 710. The I/O units 731 and 732 may be a combined unit including communication equipment towards several entities/elements, or may include a distributed structure with a plurality of different interfaces for different entities/elements. Reference sign 720 denotes a memory usable, for example, for storing data and programs to be executed by the processor or processing function 710 and/or as a working storage of the processor or processing function 710. It is to be noted that the memory 720 may be implemented by using one or more memory portions of the same or different type of memory, but may also represent an external memory, e.g. an external database provided on a cloud server.

The processor or processing function 710 is configured to execute processing related to the above described processing. In particular, the processor or processing circuitry or function 710 includes one or more of the following sub-portions. Sub-portion 711 is an obtaining portion, which is usable as a portion for obtaining a configuration. The portion 711 may be configured to perform processing according to S510 of FIG. 5. Further, sub-portion 712 is a determining portion, which is usable as a portion for determining an update requirement. The portion 712 may be configured to perform processing according to S520 of FIG. 5. Moreover, sub-portion 713 is an initiating portion, which is usable as a portion for initiating an UL transmission. The portion 713 may be configured to perform processing according to S530 of FIG. 5. Sub-portion 714 is a transmitting portion, which is usable as a portion for transmitting the initiated UL transmission. The portion 714 may be configured to perform processing according to S540 of FIG. 5. Further, sub-portion 715 is a receiving portion, which is usable as a portion for receiving a response. The portion 715 may be configured to perform processing according to S550 of FIG. 5. Moreover, sub-portion 716 is an establishing portion, which is usable as a portion for establishing an update. The portion 716 may be configured to perform processing according to S560 of FIG. 5.

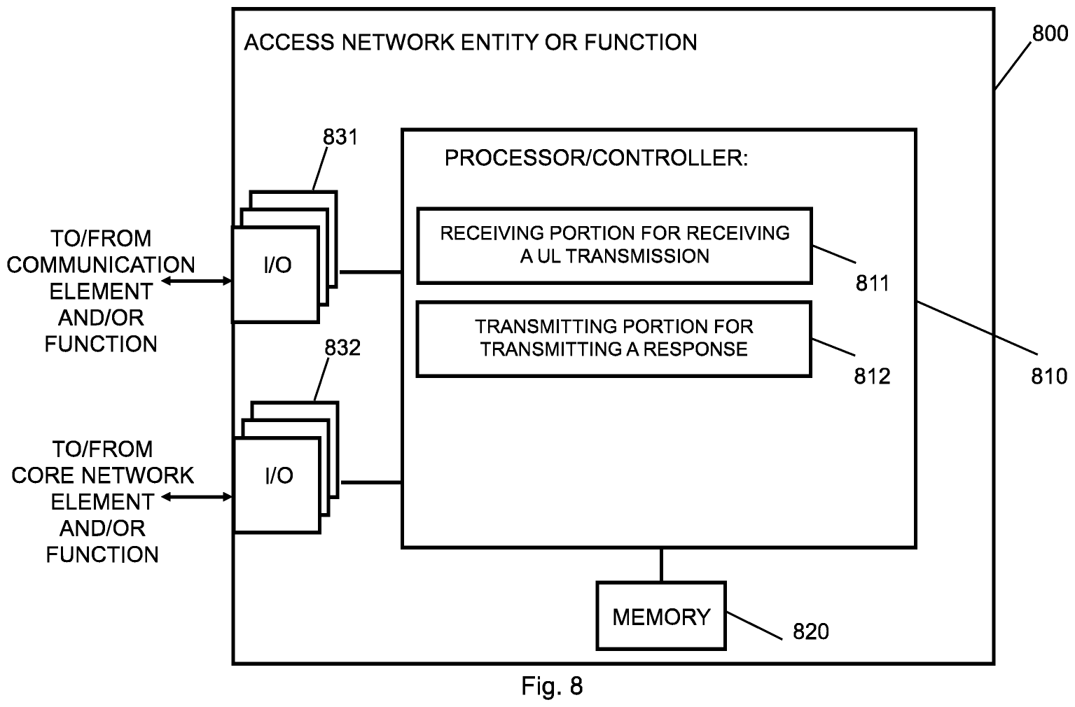

Referring now to FIG. 8, FIG. 8 shows a block diagram illustrating an apparatus according to various examples of embodiments.

Specifically, FIG. 8 shows a block diagram illustrating an apparatus, which may represent an access network entity or function, like e.g. such gNB as outlined above with reference to FIG. 4, according to various examples of embodiments, which may participate in terminal/UE initiated model-updates fora two-sided AI/MI model. Furthermore, even though reference is made to an access network entity or function, the access network entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 800 shown in FIG. 8 may include a processing circuitry, a processing function, a control unit or a processor 810, such as a CPU or the like, which is suitable to enable terminal/UE initiated model-updates for a two-sided AI/MI model. The processor 810 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 831 and 832 denote input/output (I/O) units or functions (interfaces) connected to the processor or processing function 810. The I/O units 831 and 832 may be a combined unit including communication equipment towards several entities/elements, or may include a distributed structure with a plurality of different interfaces for different entities/elements. Reference sign 820 denotes a memory usable, for example, for storing data and programs to be executed by the processor or processing function 810 and/or as a working storage of the processor or processing function 810. It is to be noted that the memory 820 may be implemented by using one or more memory portions of the same or different type of memory, but may also represent an external memory, e.g. an external database provided on a cloud server.

The processor or processing function 810 is configured to execute processing related to the above described processing. In particular, the processor or processing circuitry or function 810 includes one or more of the following sub-portions. Sub-portion 811 is a receiving portion, which is usable as a portion for receiving an UL transmission. The portion 811 may be configured to perform processing according to S610 of FIG. 6. Further, sub-portion 812 is a transmitting portion, which is usable as a portion for transmitting a response. The portion 812 may be configured to perform processing according to S620 of FIG. 6.

It shall be noted that the apparatuses 700 and 800 as outlined above with reference to FIGS. 7 and 8 may comprise further/additional sub-portions, which may allow the apparatuses 700 and 800 to perform such methods/method steps as outlined above with reference to FIG. 4.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1. A method comprising,
obtaining, at a terminal assigned to a network, a configuration with parameters that enable the terminal to initiate an uplink transmission related to an update at the terminal at least for a terminal part of a two-sided model used at the terminal, wherein the two-sided model is used for joint model inference at the terminal and the network;
determining that an update of the two-sided model is required;
initiating, based on the obtained configuration, a first UL transmission;
transmitting the initiated first UL transmission indicating the required update;
receiving a response comprising update information related to the required update; and
based on the received response, establishing an update of the terminal part of the two-sided model.

2. The method according to claim 1,
wherein the first UL transmission comprises a request for an update of the two-sided model.

3. The method according to claim 1, further comprising updating the terminal part of the two-sided model based on a result obtained from the determining,
wherein the first UL transmission comprises an approval for the updated terminal part of the two-sided model, and
wherein the establishing comprises establishing the approved updated terminal part.

4. The method according to claim 3,
wherein the updating comprises
obtaining, from a remote server, a second data set usable by the two-sided model newer than a first data set currently used by the two-sided model; and
updating the terminal part of the two-sided model based on the obtained second data set.

5. The method according to claim 1,
wherein the determining comprises
determining that a second data set usable by the two-sided model newer than a first data set currently used by the two-sided model is provided at a remote server.

6.-15. (canceled)

16. An apparatus, comprising:
at least one processor; and
at least one memory storing instructions that, when executed by the at least one processor, cause the apparatus at least to:
obtain a configuration with parameters that enable the apparatus assigned to a network to initiate an uplink transmission related to an update at the apparatus at least for an apparatus part of a two-sided model used at the apparatus, wherein the two-sided model is used for joint model inference at the apparatus and the network;
determine that an update of the two-sided model is required;
initiate, based on the obtained configuration, a first UL transmission;
transmit the initiated first UL transmission indicating the required update;
receive a response comprising update information related to the required update; and
based on the received response, establish an update of the apparatus part of the two-sided model.

17. The apparatus according to claim 16,
wherein the first UL transmission comprises a request for an update of the two-sided model.

18. The apparatus according to claim 17, wherein the apparatus is further caused to
update the apparatus part of the two-sided model based on a result obtained from the determining,
wherein the first UL transmission comprises an approval for the updated apparatus part of the two-sided model, and
wherein the establishing comprises that the apparatus is further caused to establish the approved updated apparatus part.

19. The apparatus according to claim 18,
wherein the updating comprises that the apparatus is further caused to
obtain, from a remote server, a second data set usable by the two-sided model newer than a first data set currently used by the two-sided model; and
update the apparatus part of the two-sided model based on the obtained second data set.

20. The apparatus according to claim 16,
wherein the determining comprises that the apparatus is further caused to
determine that a second data set usable by the two-sided model newer than a first data set currently used by the two-sided model is provided at a remote server.

21. The apparatus according to claim 16,
wherein the parameters contain at least one of
radio resources to be used in the first UL transmission,
a data format and/or transmission format to be used in the first UL transmission, or
information to be carried in the first UL transmission, wherein the information comprises at least one of
information related to a data set useable or used to update the two-sided model,
information related to inference complexity related to the apparatus part or updated apparatus part of the two-sided model,
information related to inference latency related to the apparatus part or updated apparatus part of the two-sided model,
information related to a configuration of the apparatus part or updated apparatus part of the two-sided model,
information related to output changes of the two-sided model associated with the apparatus part or updated apparatus part of the two-sided model,
a duration required to update the apparatus part of the two-sided model, or
a possibility to apply the apparatus part or updated apparatus part of the two-sided model during an update duration for updating the two-sided model.

22. The apparatus according to claim 16, wherein the apparatus is further caused to,
responsive to the transmitted first UL transmission, receive a scheduling for a second UL transmission; and
transmit the scheduled second UL transmission comprising at least one of the following information related to the required update:
information related to a data set useable or used to update the two-sided model,
information related to inference complexity related to the apparatus part or updated apparatus part of the two-sided model,
information related to inference latency related to the apparatus part or updated apparatus part of the two-sided model,
information related to a configuration of the apparatus part or updated apparatus part of the two-sided model,
information related to output changes of the two-sided model associated with the apparatus part or updated apparatus part of the two-sided model,
a duration required to update the apparatus part of the two-sided model, or
a possibility to apply the apparatus part or updated apparatus part of the two-sided model during an update duration for updating the two-sided model.

23. The apparatus according to claim 18, wherein the apparatus is further caused to
receive the response comprising the update information responsive to the transmitted first UL transmission or the second UL transmission, wherein the update information comprises at least one of the following:
if the first UL transmission comprises the request, an indication about whether or not the apparatus part of the two-sided model is updateable,
if the first UL transmission comprises the request, an indication about whether or not to pause use of the two-sided model during an update duration for updating the two-sided model,
if the first UL transmission comprises the request, a configuration comprising an update to the apparatus part of the two-sided model,
if the first UL transmission comprises the approval, an indication about whether or not the approval is rejected,
a configuration about how to switch in an update duration for updating the two-sided model, or
an indication to continue with using the two-sided model without updating the two-sided model.

24. The apparatus according to claim 16, wherein the apparatus is further caused to
based on the received response, switch to the updated two-sided model; and
indicate the switch to the updated two-sided model by either a control plane or user plane.

25. The apparatus according to claim 16,
wherein the two-sided model is a two-sided Artificial Intelligence/Machine Learning (AI/ML) model.

26. An apparatus, comprising:
at least one processor; and
at least one memory storing instructions that, when executed by the at least one processor, cause the apparatus at least to:
wherein the apparatus is an access network entity or function of a network,
receive, from a terminal assigned to the network, a first uplink transmission indicating that an update is required at least for a terminal part of a two-sided model used at the terminal, wherein the two-sided model is used for joint model inference at the terminal and the network; and
transmitting a response comprising update information related to the required update.

27. The apparatus according to claim 26, wherein the apparatus is further caused to
provide to the terminal a configuration with parameters that enable the terminal to initiate the first UL transmission,
wherein the parameters contain at least one of
radio resources to be used in the first UL transmission,
a data format or transmission format to be used in the first UL transmission, or
information to be carried in the first UL transmission, wherein the information comprises at least one of
information related to a data set useable or used to update the two-sided model,
information related to inference complexity related to the terminal part or an updated terminal part of the two-sided model,
information related to inference latency related to the terminal part or an updated terminal part of the two-sided model,
information related to a configuration of the terminal part or an updated terminal part of the two-sided model,
information related to output changes of the two-sided model associated with the terminal part or an updated terminal part of the two-sided model,
a duration required to update the terminal part of the two-sided model, or
a possibility to apply the terminal part or an updated terminal part of the two-sided model during an update duration for updating the two-sided model.

28. The apparatus according to claim 26, wherein the apparatus is further caused to
responsive to the received first UL transmission, schedule a second UL transmission; and
receive the scheduled second UL transmission comprising at least one of the following information related to the required update:
information related to a data set useable and/or used to update the two-sided model,
information related to inference complexity related to the terminal part or an updated terminal part of the two-sided model,
information related to inference latency related to the terminal part or an updated terminal part of the two-sided model,
information related to a configuration of the terminal part or an updated terminal part of the two-sided model,
information related to output changes of the two-sided model associated with the terminal part or an updated terminal part of the two-sided model,
a duration required to update the terminal part of the two-sided model, or
a possibility to apply the terminal part or an updated terminal part of the two-sided model during an update duration for updating the two-sided model.

29. The apparatus according to claim 26, wherein the apparatus is further caused to perform at least one of the following responsive to the received first UL transmission or the received second UL transmission:
obtain a data set to update the two-sided model from a remote server and obtain requirements to update the network side of the two-sided model,
update the network side of the two-sided model,
if the first UL transmission comprises a request for an update of the two-sided model, indicate to the terminal about whether or not the terminal part of the two-sided model is updateable,
if the first UL transmission comprises an approval for an updated terminal part of the two-sided model, determine about whether or not to reject the approval,
if the first UL transmission comprises a request for an update of the two-sided model, pause use of the two-sided model during an update duration for updating the two-sided model,
indicate to the terminal to continue with using the two-sided model without updating the two-sided model,
configure parameters related to the two-sided model in order to support joint inference with an updated terminal part of the two-sided model, or
trigger an update of the two-sided model at another access network entity or function and/or at another terminal.

30. The apparatus according to claim 26, wherein the apparatus is further caused to
receive an indication that the terminal has switched to an updated two-sided model by either a control plane or user plane.

31.-32. (canceled)
